(19) United States
(12) Patent Application Publication
(10) Pub. No.: US 2009/0128283 A1
(43) Pub. Date: May 21, 2009

(54) METHOD FOR CONTROLLING AN APPARATUS FOR SHOT PROCESSING, THE APPARATUS FOR THE SHOT PROCESSING USING THE METHOD, AND A PROGRAM FOR IMPROVING THE PERFORMANCE THEREOF

(76) Inventors: Shigeru Yamamoto, Aichi (JP); Mitsuo Ishikawa, Aichi (JP); Yoshiaki Okada, Aichi (JP); Keiji Suzuki, Aichi (JP); Takashi Tatematsu, Aichi (JP)

Correspondence Address: FINNEGAN, HENDERSON, FARABOW, GARRETT & DUNNER;LLP, 901 NEW YORK AVENUE, NW, WASHINGTON, DC, 20001-4413, US

(21) Appl. No.: 12/097,203

(22) PCT Filed: Nov. 20, 2006
(86) PCT No.: PCT/JP2006/323118

§ 371 Date: Jun. 12, 2008

(30) Foreign Application Priority Data
Dec. 16, 2005 (JP) 2005-362765

(51) Int. Cl. G05B 19/00; G08B 23/00; G08B 3/00

(52) U.S. Cl. 340/5.1; 340/540; 340/691.6

(57) ABSTRACT

The inventions relate to 1) a method for controlling the apparatus for the shot processing to safely activate it, the apparatus for the shot processing using the method for controlling, and a computer program for it, 2) a method for controlling the apparatus to improve the performance of it, the apparatus using the method for controlling, and a computer program for it, and 3) a method for controlling the apparatus to prevent a fire from breaking out in a dust collector which catches dust generated by it, the apparatus using the method for controlling, and a computer program for it.

The method for controlling an apparatus for shot processing to securely activate the apparatus, which is provided with a panel for operation to control the apparatus, is comprised of 1) a step for displaying a screen indicating predetermined items to be checked to confirm the safety of the apparatus and key buttons to select answers on the touch panel of the panel for operation when the apparatus is activated, 2) a step for touching the key buttons to select answers corresponding to the items to be checked, 3) a step for determining whether it has been confirmed that the apparatus can be securely activated after the step for touching the key buttons, and 4) a step for switching the screen on the touch panel to a predetermined different screen based on the result of the step for that determination.

### TECHNICAL FIELD

These inventions relate to a method for controlling an apparatus for shot processing, the apparatus for the shot processing using the method, and a program for improving the performance of the apparatus.

Particularly, these inventions relate to an apparatus for shot processing to remove oxide scales or burrs of a cast metal, to treat a surface of products, such as a wire, a steel sheet, or a molded steel, or to improve the fatigue strength of metal products by projecting shots at the surface of them. These inventions are comprised of:

1. the method for controlling the apparatus for the shot processing to securely activate it, the apparatus for the shot processing using the method for controlling, and a computer program for controlling the apparatus to securely activate it,
2. the method for controlling the apparatus for the shot processing to improve the performance of it, the apparatus for the shot processing using the method for controlling, and the computer program for controlling the apparatus to improve the performance of it, and
3. the method for controlling the apparatus for the shot processing to prevent a fire from breaking out in a dust collector which catches dust generated by the apparatus for the shot processing, the apparatus for the shot processing using the method for controlling, and the computer program for controlling the apparatus to prevent a fire from breaking out in the dust collector which is connected to the apparatus. (Here, “to prevent a fire from breaking out in the dust collector” means to reduce the possibility of a fire breaking out in the dust collector.)

### BACKGROUND OF THE INVENTION

Conventionally, there is an apparatus for shot processing which guarantees the quality of a product treated by shot-peening processing by means of monitoring whether the apparatus is driven within predetermined conditions (for example, see Patent Document 1). For the apparatus for the shot-peening processing, based on the following procedures it is determined whether the processing is appropriate. Namely the proper conditions to operate the apparatus to be able to get a product having a desired surface by the shot-peening processing are preliminarily input into a device for controlling the apparatus. Next, the data representing the status of the apparatus corresponding to the predetermined conditions are monitored and checked by various sensors. Then, when the data are within an allowable range, it is determined that the processing of the shot peening has been appropriately performed.

Generally, the apparatus for the shot-peening processing is connected to a dust collector. The dust collector is used as incidental equipment for it, to catch the dust generated by it. The incidental equipment for the apparatus for the shot-peening processing may include a device for pouring a precoat material to reduce the flammability of the dust. Since the powder of the precoat material, which is poured by the device for pouring it, is absorbed on a filter of the dust collector together with the dust while the dust collector is in operation, and is mixed with the dust, the flammability of the dust can be reduced (for example, see Patent Document 2).

For the conventional apparatus, it can guarantee the quality of the product treated by the shot-peening processing after it starts to work. However, since when it starts to work no measures to prevent an accident are preliminarily taken, an unexpected failure may occur.

For an example to solve this problem, there is a safety device for a self-propelled construction machine to prevent an accident by having an operator confirm the safety conditions by a visual check before driving the machine (for example, see Patent Document 3). For this safety device, one or more means for inputting safety signals, which are input when it is verified that there is no obstruction around the self-propelled construction machine, are disposed around the machine. When all safety signals are input by the means for inputting them, the self-propelled construction machine can be ready to move.

However, since these means for inputting the safety signals are dispersed around the self-propelled construction machine, it is necessary to identify these means so as to distinguish one which has already input the safety signal from others which have not yet input such a signal. It is also necessary to move to locations where these means are disposed for inputting the safety signals. Thus, the operation for inputting the safety signals is quite complex. Further, if the engine of the construction machine will not start, it becomes a problem, in that it is necessary to search for means for inputting the safety signals that have not yet been input. It would also become a problem in that it would be difficult to immediately identify whether the engine will not start because of the reason for the failure itself.

For the future, it becomes necessary to consider the health of an operator, as well as to consider the workability of a machine. The responsibility of an employer for safe management of occupational health and safety becomes important.

For the conventional apparatus explained in the above paragraphs, while the apparatus for the shot processing is in operation, if it becomes unexpectedly necessary to supply consumables, the efficiency of the apparatus is reduced. Further, while supplying the consumables, the motors of the apparatus continue to operate even if the shot processing is interrupted. Thus, the cost to drive the apparatus could increase because power must be supplied to the motors.

Further, for the conventional apparatus explained in the above paragraphs, in the present circumstances, only the operator maintains the safety of the apparatus for the shot processing which is in operation. Thus, the operator may start to operate the apparatus for the shot processing without confirming that the conditions are safe to do so, that is, say, to confirm whether the collected dust, which could cause a fire, in the dust collector has already been discharged, or whether a precoat material has already been replenished.
Patent Document 1: Japanese Patent Laid-open Publication No. 2003-11061
Patent Document 2: Japanese Utility Model Laid-open Publication No. H6-85018
Patent Document 3: Japanese Patent Laid-open Publication No. 2004-92347

### DISCLOSURES OF INVENTIONS

The purpose of these inventions is to provide a method for controlling an apparatus for shot processing to securely activate it, the apparatus for shot processing using the method, and a program for controlling the apparatus to securely activate it, in order to notify an operator whether there are safety problems in regards to the apparatus for the shot processing when it is activated, and to maintain safety while it is in operation.

Another purpose of these inventions is to provide a method for controlling the apparatus for the shot processing, the apparatus for the shot processing using the method for controlling, and a computer program for controlling the apparatus, in order to improve the performance of it and reduce the cost for operating it.

Another purpose of these inventions is to provide a method for controlling the apparatus for the shot processing, the apparatus for the shot processing using the method for controlling, and a computer program for controlling the apparatus, to prevent a fire from breaking out in the dust collector, which catches dust generated by the apparatus for the shot processing.

According to the first aspect of these inventions, the method for controlling the apparatus for the shot processing to securely activate the apparatus, which is provided with a panel for operation to control it, comprises the following: a step for displaying a screen indicating predetermined items to be checked to confirm the safety of the apparatus and key buttons to select answers on the touch panel of the panel for operation when the apparatus is activated, a step for touching the key buttons to select answers corresponding to the items to be checked, a step for determining whether it has been confirmed that the apparatus can be securely activated after the step for touching the key buttons, and a step for switching the screen on the touch panel to a predetermined different screen based on the result of the step for that determination.

Further, regarding the apparatus for shot processing of these inventions using the above method, which apparatus is provided with a panel for operation to control it, the apparatus comprises: a displaying means to display a screen indicating predetermined items to be checked to confirm the safety of the apparatus and key buttons to select answers on the touch panel of the panel for operation when the apparatus is activated, a determining means to determine whether it has been confirmed that the apparatus can be securely activated after touching the key buttons to select answers corresponding to the items to be checked, and a switching means to switch the screen on the touch panel to a predetermined different screen based on the result of the determining means.

Further, regarding the program for controlling the apparatus for the shot processing of these inventions to securely activate it, which apparatus is provided with a panel for operation and a computer to control it, the program comprises: a means for displaying a screen indicating predetermined items to be checked to confirm the safety of the apparatus and key buttons to select answers on the touch panel of the panel for operation when the apparatus is activated, a means for determining whether it has been confirmed that the apparatus can be securely activated after touching the key buttons to select answers corresponding to the items to be checked, and a means for switching the screen on the touch panel to a predetermined different screen based on the result of the means for that determination.

Regarding the second aspect of these inventions, namely, the method for controlling an apparatus for shot processing to improve the performance of it, which apparatus is provided with a panel for operation to control it, the method comprises: a step for inputting the names of the consumables and the periods for exchanging the consumables by means of the touch panel of the panel for operation, a step for storing the names of the consumables and the periods for exchanging the consumables, and a step for displaying, on the touch panel of the panel for operation, after a predetermined time has passed, a screen giving instructions to exchange the consumables.

Further, regarding the apparatus for shot processing of these inventions using the method, which apparatus is provided with a panel for operation to control it, the apparatus comprises: an inputting means to input the names of consumables and the periods for exchanging the consumables by means of the touch panel of the panel for operation, a storing means to store the names of the consumables and the periods for exchanging the consumables, and a display means to display, on the touch panel of the panel for operation, after a predetermined time has passed, a screen giving instructions to exchange the consumables.

Further, regarding the program for controlling the apparatus for the shot processing of these inventions to improve the performance of it, which apparatus is provided with a panel for operation and a computer to control it, the program comprises: a means for inputting the names of consumables and the periods for exchanging the consumables by means of the touch panel of the panel for operation, a means for storing the names of the consumables and the periods for exchanging the consumables, and a means for displaying, on the touch panel of the panel for operation, after a predetermined time has passed, a screen giving instructions to exchange the consumables.

Regarding the third aspect of these inventions, i.e., the method for controlling the apparatus for shot processing to prevent a fire from breaking out in a dust collector which catches dust generated by the apparatus for the shot processing, and to securely activate it, which apparatus is provided with a panel for operation to control it, the method comprises: a step for displaying a screen indicating predetermined items to be checked to prevent a fire from breaking out in the dust collector and key buttons to select answers on the touch panel of the panel for operation when the apparatus is activated, a step for touching the key buttons to select answers corresponding to the respective items to be checked, a step for determining whether it has been confirmed that the apparatus can be securely activated after the step for touching the key button, and a step for switching the screen on the touch panel to a predetermined different screen based on the result of the step for that determination.

Further, regarding the apparatus for shot processing of these inventions, which apparatus has a function of verification for preventing a fire from breaking out in the dust collector which catches dust generated by the apparatus for the shot processing, and for securely activating it, and which apparatus is provided with a panel for operation to control it, the apparatus comprises: a displaying means to display a screen indicating predetermined items to be checked to prevent a fire from breaking out in the dust collector and key buttons to select answers on the touch panel of the panel for operation when the apparatus is activated, a determining means to determine whether it has been confirmed that the apparatus can be securely activated after the step for touching the key buttons to select answers corresponding to the respective items to be checked, and a switching means to switch the screen on the touch panel to a predetermined different screen based on the result of the determining means.

Further, regarding the program for controlling the apparatus for the shot processing of this invention to prevent a fire from breaking out in the dust collector which catches dust generated by the apparatus for the shot processing, which apparatus is provided with a panel for operation and a computer to control it, the program comprises: a means for displaying a screen indicating predetermined items to be checked to prevent a fire from breaking out in the dust collector and key buttons to select answers on the touch panel of the panel for operation when the apparatus is activated, a means for determining whether it has been confirmed that the apparatus can be securely activated after touching the key buttons to select answers corresponding to the respective items to be checked, and a means for switching the screen on the touch panel to a predetermined different screen based on the result of the determining means.

According to the first aspect of these inventions, since the operators must respond to the predetermined items to be checked to confirm the safety of the apparatus for the shot processing while watching the screen of the touch panel of the panel for operation, it is possible to invite their attention to confirm the safety of the apparatus when it is activated. Further, in these inventions, when the entire set of the items to be checked to confirm the safety of the apparatus is identified as being safe, the apparatus can be activated. If just one of the items to be checked is identified as not being safe, the apparatus cannot be activated. Thus, it is possible to maintain the safety of the operation of the apparatus.

According to the second aspect of these inventions, since the system can indicate the instructions for exchanging the consumables, the operators can operate the apparatus in a systematic manner. Thus, it is possible to improve the performance of the apparatus for the shot processing, and to reduce the cost of the operation of it.

According to the third aspect of these inventions, since the operators must respond to the predetermined items to be checked to confirm the safety of the apparatus for the shot processing to prevent any fire from breaking out in the dust collector while watching the screen of the touch panel of the panel for operation, it is possible to attract their attention to confirm the safety of the apparatus to prevent a fire from breaking out in the dust collector. Further, in these inventions, when the entire set of the items to be checked to confirm the safety of the apparatus to prevent a fire from breaking out in the dust collector is identified as being safe, the apparatus can be activated. If just one of the items to be checked is identified as not being safe, the apparatus cannot be activated. Thus, it is possible to prevent a fire from breaking out in the dust collector and to securely activate the apparatus.

### PREFERRED EMBODIMENTS OF THE INVENTIONS

The apparatus of these inventions may be used for shot processing to remove oxide scales or burrs of a cast metal, or to treat a surface of products, such as a wire, a steel sheet, or a molded steel. This apparatus is provided with a panel for operation to control it and can store the conditions for processing the treatment of the surface of the products and for controlling the apparatus. Namely, the apparatus of these inventions is not limited to a specific machine for shot processing. For these inventions, for example, a various type of apparatus for the shot processing, such as the following, can be used: (1) an apparatus for shot blasting to project the shots at surfaces of products to be cleaned, which products are disposed on a table located in a cabinet that constitutes a room for cleaning the products, (2) an apparatus for shot blasting to project the shots at surfaces of products to be cleaned, which products are disposed in a drum that is attached to an inclined rotating axis, (3) an apparatus for shot blasting to project the shots at surfaces of products to be cleaned, which products are hung by a hanger-type conveyor and transferred, (4) an apparatus for shot blasting to project the shots at products, such as a steel wire or plate, to treat their surfaces, which products are conveyed by a conveyor, (5) an apparatus for shot blasting having a pipe for supplying shot to blades of a rotating plate, and (6) an apparatus for shot-peening to carry out a peening process. Further, a various type of device for projecting shots, such as a centrifugal or pneumatic blasting-type device, and a dry- or wet-type, can be used.

First, the inventions according to the first aspect are explained based on the figures. These inventions relate to a method for controlling the apparatus for the shot processing to safely activate it, to the apparatus for the shot processing using the method for controlling, and a computer program for controlling the apparatus to securely activate it.

The panel for operation to control the apparatus for the shot processing, which was previously explained, has a computer (CPU) and a controller. It is designed so that it can monitor the operating conditions of the apparatus. The computer of the panel for operation is provided with a computer program to confirm whether the apparatus can be securely activated. The program has a displaying means to display a screen indicating predetermined items to be checked, a determining means to determine the safety of the apparatus, and a switching means to switch the screen on the touch panel. The controller has a computer program (software) that is stored in it that may be used. It has a function that may be used to decide the operating procedures of the apparatus so as to operate the apparatus based on signals generated by sensors. For example, a programmable logic controller (PLC) can be used as the controller. The panel for operation may be designed so as to change the values in order to control the operating conditions of the apparatus.

The displaying means has a function for displaying a screen indicating the predetermined items to be checked to confirm the safety of the apparatus and key buttons to select answers on the touch panel of the panel for operation when the apparatus is activated. The entire surface of the touch panel may be covered with a transparent film. The touch panel, which can detect the position that an operator touches so as to identify key buttons, for example, “YES” or “NO,” may be used when necessary. It is not limited to a panel of a specific type. The key buttons can be selected by a finger of the operator, a pen tip, or a pointing means, such as a pen-type means, of a device for inputting data. As the predetermined items to be checked, there are items regarding the physical conditions (health conditions) of the operators, protective equipment for them, the circumstances around the apparatus, conditions of the apparatus, and so on. For the preferred embodiment of these inventions, as shown in FIGS. 1 and 2, the following items are displayed in the screen of the touch panel 1 together with the key buttons 2 for selecting “YES” or “NO.”
“1. How is your physical condition?”
“2. Are you wearing protective equipment, such as protective glasses?”
“3. Is there anyone in the apparatus or in the dangerous area around it?”
“4. Is the door of the cabinet securely closed?”
“5. Is no shot scattered around the apparatus?”
“6. Has the dust in the dust collector already been discharged?”
“7. Has the safety cover already been installed?”
“8. Is no cover of the impeller open?”
“9. Is there any trouble with the safety devices or the sensors?”

After the operators operate the key buttons 2, that is, touching the key buttons for “YES” or “NO” that correspond to the predetermined items to be checked, when, for example, they touch the key button “OK” disposed at the lower portion of the screen, as shown in FIG. 2, the determining means starts to determine whether it has been confirmed that the apparatus for the shot processing can be securely activated. The result of the judgment of the determining means is indicated by switching the screen of the touch panel by means of the switching means together with the information for proceeding to the next steps. For example, if the operators touch the key button “NO,” the determining means judges that the apparatus for the shot processing cannot be securely activated. In this case, the switching means switches the screen 1 of the touch panel shown in FIG. 3 to screen 1a, giving instructions to confirm that the apparatus for the shot processing can be securely activated. For this embodiment, according to the items to be checked for which the operators touch the corresponding key button “NO,” screen 1a indicates the following items, instructing the operator about the next operations.
“1. Inform your supervisor of your health condition.”
“2. Wear protective equipment and glasses.”
“3. Keep persons at a distance from the dangerous area around the apparatus.”
“4. Close the door of the cabinet securely.”
“5. Install the safety cover.”
“6. Close the cover of the impeller securely with the tool.”
“7. Repair or exchange the safety devices or the sensors.”
   After completing the operation based on screen 1a, giving the instructions, the operators can touch key button 4, i.e. “Completion,” located at the lower portion of the screen. By this operation, as shown in FIGS. 4 and 5, screen 1b, which indicates the state wherein the apparatus is ready to be activated, is displayed, and provides information that the apparatus is ready to be activated. Then, the switching means switches screen 1b of the touch panel to screen 1c. It displays a menu for the operation of the shot processing.

For this embodiment, the screen displaying the menu is defined as an initial screen for operating the apparatus and for showing the conditions of the apparatus during operation.

Then, if the operators touch key button 5, namely “screen for manual operation,” as shown in FIG. 6, the screen is switched to screen 1d for manual operation. For this embodiment, the screen for the manual operation is defined as a screen that indicates the functions for manually operating the apparatus. It displays key buttons to manually activate or stop rotary valves, a dust collector, a bucket elevator, or impellers. The operators can operate the apparatus, for example, to tune it based on screen 1d, for manual operation.

Further, if the operators touch key button 6, namely, “screen for operation in malfunction condition,” as shown in FIG. 7, the screen is switched to screen 1e, namely for operation in the malfunction condition. For this embodiment, the screen for the operation in the malfunction condition is defined as a screen that indicates the causes of the malfunction of the apparatus. It indicates the causes of the malfunction, such as a reaction of an area sensor, overload of a motor, opening of a door for checking out the apparatus, or that a cycle-time has been completed. The operators can operate the apparatus, for example, to verify the cause of the malfunction and to correct it based on screen 1e, for the operation in the malfunction condition.

Further, if the operators touch key button 7, “screen for setting up operating conditions,” as shown in FIG. 8, the screen is switched to screen 1f for setting up driving conditions. For this embodiment, the screen for setting up the driving conditions is defined as a screen for setting up the driving conditions of the apparatus for the shot processing to treat the specific products. It shows information for selecting the periods for projecting shots corresponding to the product number. It also indicates the periods for projecting the shots, the time for starting a mode to save energy, and the time for starting to detect when the cycle-time has been completed. The operators can set up the driving conditions of the apparatus for the shot processing to treat the specific products and register them, or call them up, based on screen 1f, for setting up driving conditions.

For this embodiment, since the operators have to respond to the predetermined items to be checked to confirm the safety of the apparatus for the shot processing while watching the screen of the touch panel of the panel for operation, it is possible to draw their attention to confirm the safety of the apparatus when it is activated. Further, after the operation for confirming the safety of the apparatus, since the operators can get the necessary information and operate the apparatus based on the screen displaying the menu of the operation of the apparatus, it is possible to maintain the safety of the operation of the apparatus.

For this embodiment, the touch panel is installed on the panel for operation. However, in these inventions, the constitution of the touch panel is not limited to a particular one. The touch panel can easily be attached to and removed from the panel for operation. Because of this constitution of the touch panel, the operators can carry it in their hands and operate it, if necessary.

Next, the inventions according to the second aspect are explained. They relate to a method for controlling the apparatus for the shot processing to improve the performance of it, the apparatus for the shot processing using the method for controlling, and to a computer program for controlling the apparatus to improve the performance of it.

The computer that is installed in the panel for operation may also be provided with a computer program so as to improve the apparatus for the shot processing. The computer program is comprised of a means for inputting data, a means for storing the data, a means for displaying instructions, a means for determining the state of the apparatus, and a means for giving instructions to stop the apparatus.

For the embodiment of the inventions according to the first aspect, if the confirmation of the safety of the apparatus has not been completed, the apparatus cannot be activated, and the shot processing cannot be performed. However, for these inventions, it is possible to eliminate the step to confirm the safety of the apparatus, and to immediately start the computer program for improving the apparatus for the shot processing.

Namely, for the embodiment of the inventions according to the second aspect, the means for inputting the data and the means for storing the data of the computer program for improving the apparatus allow the operators to input names of consumables and periods for exchanging the consumables by means of the touch panel of the panel for operation, and to store those data. Further, the means for displaying the instructions of the computer program for improving the apparatus can display the instructions for exchanging the consumables on the screen of the touch panel when a predetermined time has passed.

For this embodiment, if the operators touch key button 8, namely, the “screen for predicting” in FIG. 6, the screen is switched to screen 1g for predicting the state of the apparatus, as in FIG. 9. Further, if the operators touch key button 9, “next page,” as in FIG. 9, the screen is switched to screen 1h for predicting the state of the apparatus, as shown in FIG. 10. For this embodiment, the screen for predicting the state of the apparatus is defined as a screen that is used to set up the cycle times for exchanging the consumables and indicates the length of the time that has elapsed since the last exchanges. It indicates the cycle times for exchanging blades, control gauges, impeller liners, the covers of the impeller liners, a liner of a port for projecting shots, jigs for products, or an inner liner of a hanger, etc., and of the periods of time that have elapsed since the last exchanges. The operators can set up the cycle time for each consumable so as to correspond to every condition of the operation of the apparatus. The operators can also set up the screen so as to be informed of the timing for exchanging the consumables when the periods of time that have elapsed since the last exchanges reach the cycle time. Further, reset key 10 is provided for the screen so as to delete the cycle times or the periods of time that have elapsed since the last exchanges, if necessary.

For these inventions, since the operators can recognize the periods of time that have elapsed since the last exchanges of the consumables by means of the function that predicts the timing for exchanging them, they can exchange them according to task planning. Thus, it is possible to improve the efficiency of the process of the shot processing. Further, as shown in FIGS. 8, 11, and 12, if the operators touch key button 11, “next page,” of the screen 1f, for setting up operating conditions, the screen can be switched to screen 1i or 1j for setting up other operating conditions. For screen 1i or 1j, the numbers of products, the names of them, and the operating conditions corresponding to them (the periods of time for projecting the shots, the quantity of the shots, the speed of the shots projected [the frequency generated by an inverter]) can be preliminarily input. When operating the apparatus for the shot processing, the operators can easily treat the products by touching key button 12, “selecting,” to specify the numbers of products. Thus, a nonprofessional person or an operator who is untrained can easily operate the apparatus for the shot processing. Further, it is possible to simplify the procedure of the task.

For this embodiment, the computer program for improving the apparatus is provided with means for determining whether the apparatus has been used for a predetermined period during operation, and with a means for instructing the apparatus to stop if it is determined by the means for determining it that the apparatus has not been used for the predetermined period. Since this function for automatically stopping the apparatus can stop the driving motors to save energy, it is also possible to reduce the running cost for the shot processing.

Next, the inventions according to the third aspect are explained. They relate to a method for controlling the apparatus for the shot processing to prevent a fire from breaking out in the dust collector which catches dust generated by the apparatus for the shot processing, the apparatus for the shot processing using the method for controlling, and a computer program for controlling the apparatus to prevent a fire from breaking out in the dust collector, which is connected to the apparatus.

The inventions according to the third aspect can be applied to the apparatus for the shot processing explained in the previous embodiments. However, the apparatus to which these inventions can be applied are not limited to a particular one. Namely, the apparatus for the shot processing, which is connected to a dust collector, which is used as incidental equipment for it, to catch the dust generated by it, and which is provided with a panel for operation that has the ability to store the conditions for processing products and for controlling the apparatus and that can operate it, can use these inventions. These inventions can be applied to the apparatus for shot processing to remove oxide scales or burrs of a cast metal, to treat a surface of products, such as a wire, a steel sheet, or a molded steel, and to improve the fatigue strength of metal products by projecting shots at the surface of them. They can also be applied to the apparatus for heating and recycling waste material, the apparatus for generating fumes or spatter, etc. Further, for these inventions, the dust includes not only powder dust generated during the mechanical grinding process, but also gases that include spatters or smoke-like fumes generated during the welding process in a booth.

The apparatus for treating the surface of products includes (1) an apparatus for shot blasting to project the shots at the surface of the products to be cleaned, which products are disposed on a table located in a cabinet that constitutes a room for cleaning the products, (2) an apparatus for shot blasting to project the shots at the surface of the products to be cleaned, which products are disposed in a drum that is attached to an inclined rotating axis, (3) an apron-type apparatus for shot blasting to project the shots at the surfaces of small products having a disk-like or bar-like shape, which products are disposed in a space in a cabinet and are tumbled by an endless belt wound around the three rollers rotatably installed in the cabinet, (4) a hanger-type apparatus for shot blasting to project the shots at the surfaces of the products to be cleaned, which products are hung by a hanger-type conveyor and transferred, (5) a conveyor-type apparatus for shot blasting to project the shots at the products, such as a steel wire or plate, which products are conveyed by a conveyor, and (6) an apparatus for shot blasting having a pipe for supplying the shots to blades of a rotating plate. Further, a various type of device for projecting shots, such as a centrifugal- or pneumatic-blasting-type, and a dry- or wet-type, can be used. The apparatus for shot processing to improve fatigue strength includes an apparatus for shot-peening to increase the residual stress of the surfaces of the products, such as gears, by shot-peening by means of a centrifugal-type device for projecting shots. Here, the apparatus for shot blasting and the apparatus for shot-peening are defined as the apparatus for shot processing.

The apparatus for heating and recycling waste material includes an apparatus of a drier. It is used in a plant manufacturing asphalt mixtures. It is provided with a rotating drum to tumble the waste material and a burner to generate hot air.

Further, as the apparatus for generating fumes or spatters, etc., an apparatus for controlling the conditions in the booth surrounding the space for the welding process is included.

For these inventions, the dust collector is not limited to a specific one. For example, the dust collector that uses a bag filter or a pleated filter to collect the dust may be used. For this collector, generally the dust collected at the surface of the filter is blown clear by means of a pulse-jet. It is a way to clean the filter by blowing compressed air. Then the dust can be discharged from the body of the dust collector to a dust box at regular intervals through a discharging rotary valve disposed at the lower portion of the body. Or, the dust can be directly discharged into the dust box disposed at the lower portion of the body without using the rotary valve. Or, the dust can accumulate in the dust box through a slidable gate, and be discharged from the dust box at regular intervals.

The embodiment of the inventions according to the third aspect is now explained in detail based on the figures.

The panel for operation of this embodiment is provided with a computer (CPU) and a controller so that it can monitor the operating conditions of the apparatus. The computer of the panel for operation is provided with a computer program to confirm that the apparatus can be securely activated. The program has a means for displaying information, a means for determining the safety of the apparatus, and a means for switching a screen of a touch panel. A controller that has a computer program (software) that is stored in it, and that has a function to decide the operating procedures of the apparatus so as to operate the apparatus based on signals generated by sensors, may be used. For example, a programmable logic controller (PLC) can be used as the controller. The panel for operation may be designed so as to change the values of the operating conditions for controlling the apparatus.

The means for displaying the information has a function for displaying a screen indicating the predetermined items to be checked so as to prevent a fire, and has key buttons for selecting answers on the touch panel of the panel for operation when it is activated. The entire surface of the touch panel may be covered with a transparent film. The touch panel, which can detect a position that an operator touches so as to identify key buttons, for example, “YES” or “NO,” may be used. It is not limited to a panel of a specific type. The key buttons can be selected by a finger of the operator, a pen tip, or a pointing means, such as a pen-type device, of a device for inputting data. Among the predetermined items to be checked, there is an item for confirming whether the dust, which is collected by the collector and may cause a fire, is discharged. This item is to be confirmed by the operators when the apparatus is activated. Further, if the apparatus is provided with a device for pouring a precoat material as incidental equipment for it, there is an item for confirming the state of the precoat material, such as a powder of calcium carbonate or calcium hydroxide, namely, whether the precoat material has already been supplied, or how much of the precoat material has been consumed. For this embodiment of this invention, as shown in FIG. 13, screen 1k, “Confirming Safety Conditions,” has key buttons 13, “Do” and “Tested.” If the operators select key button 13a, “Do,” the following items to be checked in regards to the dust collector and key button 14, “YES” and “NO,” are displayed in screen 11 of the touch panel to confirm the state of it.
“1. Is the dust collected by the dust collector been discharged from it?”
“2. Is the dust box disposed under the dust collector empty?”
   About the device for pouring the precoat material,
“3. Is the device for pouring a precoat material filled with the powder of the calcium carbonate or the calcium hydroxide up to the upper limit?”
“4. Is the powder of the calcium carbonate or the calcium hydroxide properly consumed?”
   Key buttons 15, “existence” and “nonexistence,” are displayed in FIG. 14. These key buttons are used to identify whether the apparatus is provided with the device for pouring the precoat material. The reason for using these key buttons is that it becomes possible to use a computer program accommodating an apparatus which has a device for pouring or not pouring a precoat material. Thus, since both of the apparatuses can use a panel for operation which is provided with the same computer program, it becomes possible to reduce the manufacturing cost of the panel for operation.

After the operators have operated key buttons 14, namely, touching the key buttons “YES” or “NO,” corresponding to the predetermined items to be checked, when, for example, the operators touch key button 16, “OK,” shown in FIG. 14, the means for determining starts to determine whether it has been confirmed that the apparatus for the shot processing is secure when it is activated. After the screen is switched to a predetermined screen by the means for switching a screen, data on the subsequent procedures are transmitted to the operators based on the result that is determined by the means for determination. For example, if the operators touch key button “NO,” the means determines that it has not been confirmed that the apparatus for the shot processing is securely activated. Then screen 1k of the touch panel is switched to screen 1m. It instructs the operators to confirm the items to be checked for preventing a fire by the means for switching a screen. For this embodiment, the items for which the operators touch the key button “NO” are selected from the predetermined items to be checked to prevent a fire, and screen 1m displays the following instructions corresponding to the selected items.
“1. Discharge the dust from the dust collector.”
“2. Empty the dust box.”
“3. Supply the device for pouring a precoat material with the powder of the calcium carbonate or the calcium hydroxide.”
“4. Inspect the device for pouring a precoat material based on the service manual of the equipment for preventing a fire in the device.”
   After completing the operation based on screen 1m indicating the instructions, the operators can touch key button 17, “Completion,” located at the lower portion of the screen. According to this operation, as shown in FIG. 16, screen 1n, for activating the apparatus, is displayed and informs the operator that the apparatus is ready to be activated. Then, the switching means switches the screen of the touch panel to a screen indicating a menu of the operation of the shot blasting. For this embodiment, the screen indicating the menu is defined as an initial screen for operating the apparatus. It includes, for example, the screen for manually operating the apparatus, the screen for the operation in the malfunction condition, which indicates the causes of the malfunction of the apparatus, the screen for setting up the operating conditions according to the products, and the screen for predicting the status of the apparatus. The status is used to set up the cycle times for exchanging the consumables and indicates the periods of time that have elapsed since they have been exchanged.

Before screen 1n, for activating the apparatus, is displayed, as shown in FIG. 17, screen 1o, which indicates items to be checked to maintain the apparatus, may be displayed, if necessary. For this embodiment, screen 1o indicates the following items as the items to be checked to maintain the apparatus.
“1. After activating the dust collector, inspect the differential pressure of the filter to see if it is within the scope of control. If it is outside of the scope, inspect the filter.”
“2. Do the test for flammability of the dust at least once a week (when the operating time per day is eight hours) based on the service manual of the equipment for preventing a fire in the device.”
   By giving instructions on the task to maintain the apparatus, it is also possible to draw the operator's attention to confirm the safety of the apparatus when it is activated.

For this embodiment, since the operators have to respond to the predetermined items to be checked to prevent a fire from breaking out in the dust collector while watching the screen of the touch panel, it is possible to draw their attention to confirm the safety of the apparatus when it is activated. Further, after the operation for confirming the safety of the apparatus is completed, since the operators can get the necessary information and operate the apparatus based on the screen indicating the menu of the operation of the apparatus, it is possible to maintain the safety of the operation of the apparatus.

For this embodiment, the touch panel is installed on the panel for operation. However, in this invention, the constitution of the touch panel is not limited to a particular one. The touch panel can easily be modified so that it can be attached to and removed from the panel for operation. Because of the constitution of the touch panel, the operators can carry it in their hands and operate it, if necessary.

For this embodiment, the apparatus for the shot processing having the device for pouring the precoat material as incidental equipment for it is explained. However, it may be provided with a dust box that can store the dust in it without using the device for pouring the precoat material. It is made from refractory material.

By using these inventions together with the invention that relates to the method for controlling the apparatus for shot processing to securely activate it, since it is possible to draw the operator's attention not only to confirm the safety of the apparatus when it is activated, but also to prevent a fire in the apparatus, the operator can also maintain the safety of the operation of the apparatus. Sample screen 1p, indicating the items to be checked to confirm the safety of the apparatus when it is activated, and sample screen 1q, giving instructions on tasks to securely activate it, are shown in FIGS. 18 and 19.

### BRIEF DESCRIPTIONS OF THE DRAWINGS

FIG. 1 shows a sample screen of a touch panel of an embodiment of these inventions. It indicates the items to be checked to confirm the safety of the apparatus when it is activated.

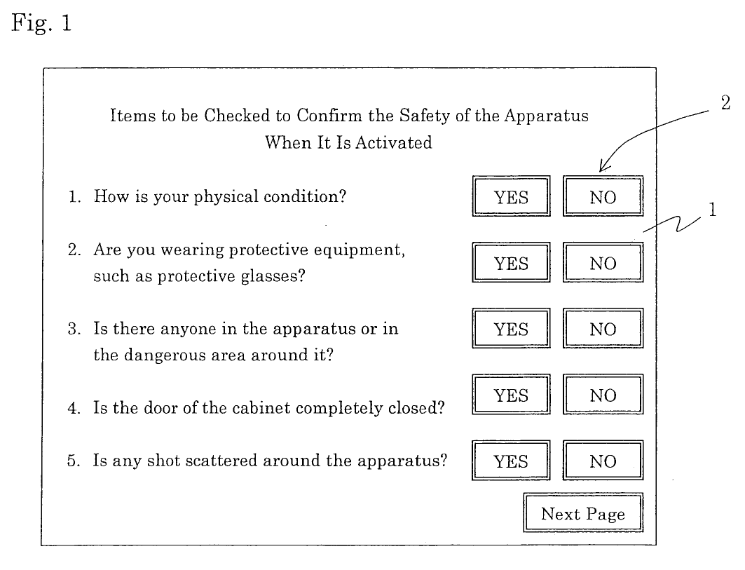

FIG. 2 shows another sample screen of a touch panel of an embodiment of these inventions. It indicates the items to be checked to confirm the safety of the apparatus when it is activated.

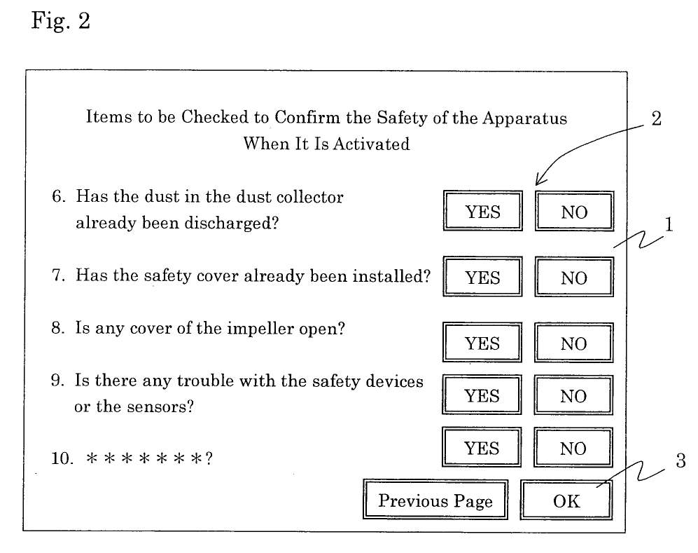

FIG. 3 shows a sample screen of an embodiment of these inventions. It gives instructions to confirm that the apparatus for the shot processing can be securely activated.

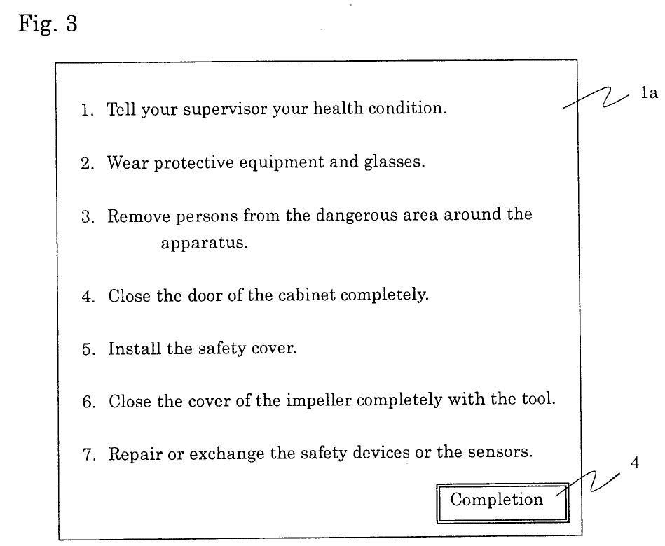

FIG. 4 shows a sample screen of an embodiment of these inventions. It indicates the state wherein the apparatus for the shot processing can be activated.

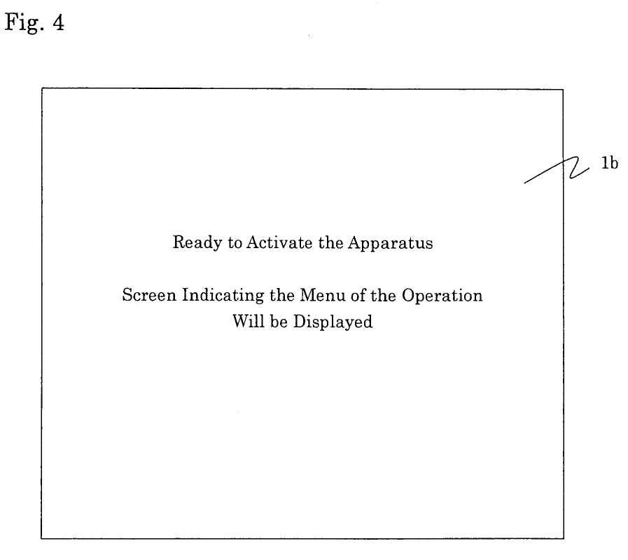

FIG. 5 shows a sample screen of an embodiment of these inventions. It indicates the menu of the operation of the shot processing.

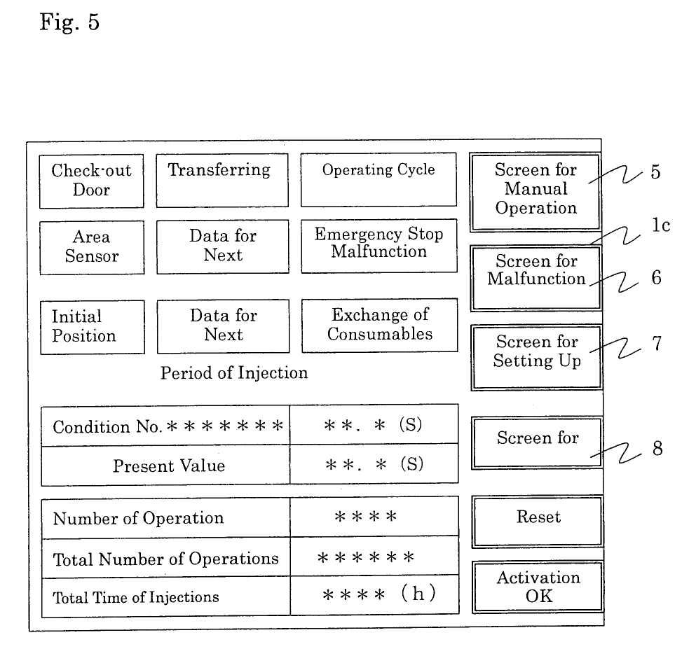

FIG. 6 shows a sample screen of an embodiment of these inventions. It indicates functions for manually operating the apparatus for the shot processing.

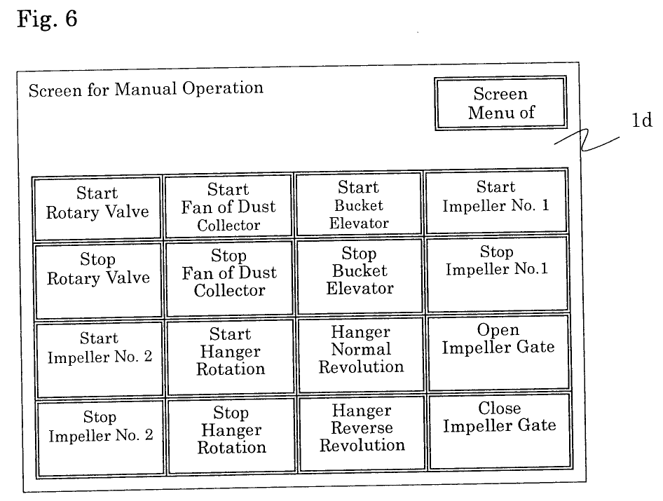

FIG. 7 shows a sample screen of an embodiment of these inventions. It indicates the causes of any malfunction of the apparatus.

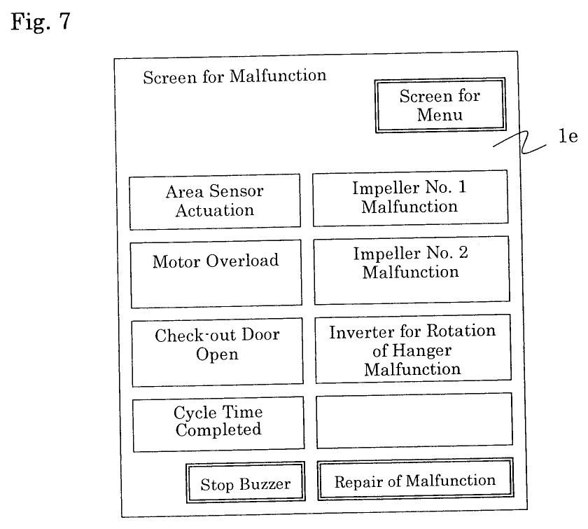

FIG. 8 shows a sample screen of an embodiment of these inventions. It is used to set up the operating conditions of the apparatus for the shot processing to treat specific products.

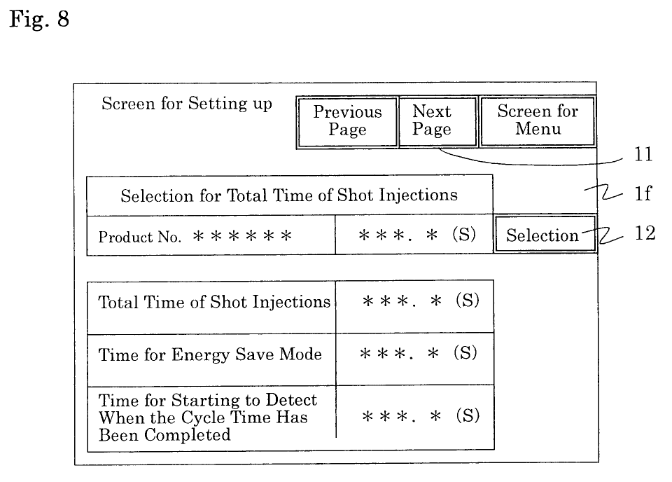

FIG. 9 shows a sample screen of an embodiment of these inventions. It predicts the state of the apparatus for the shot processing.

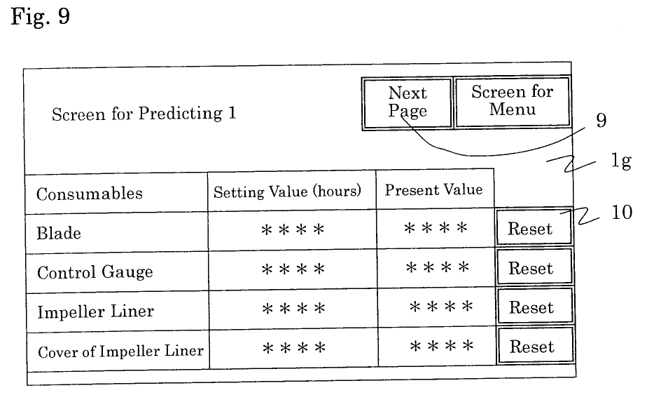

FIG. 10 shows another sample screen of an embodiment of these inventions. It predicts the state of the apparatus for the shot processing.

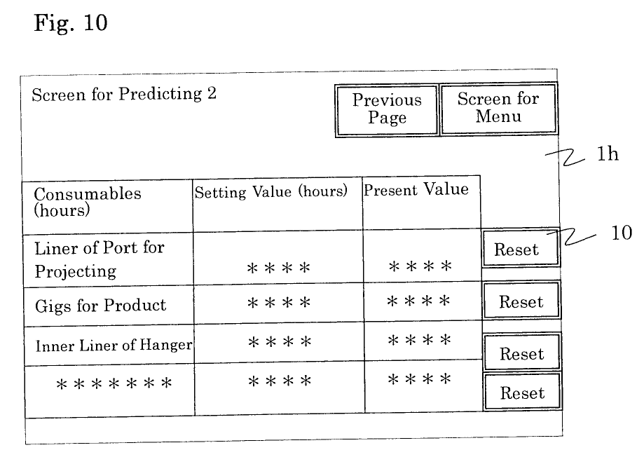

FIG. 11 shows another sample screen of an embodiment of these inventions. It is used to set up the operating conditions of the apparatus for the shot processing to treat specific products.

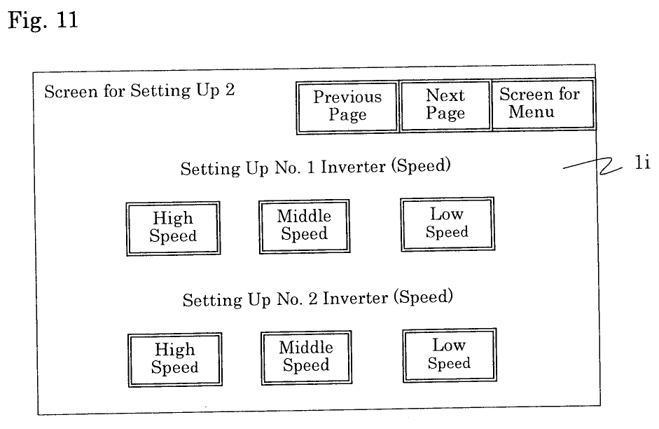

FIG. 12 shows a different sample screen of an embodiment of these inventions. It is used to set up the operating conditions of the apparatus for the shot processing to treat specific products.

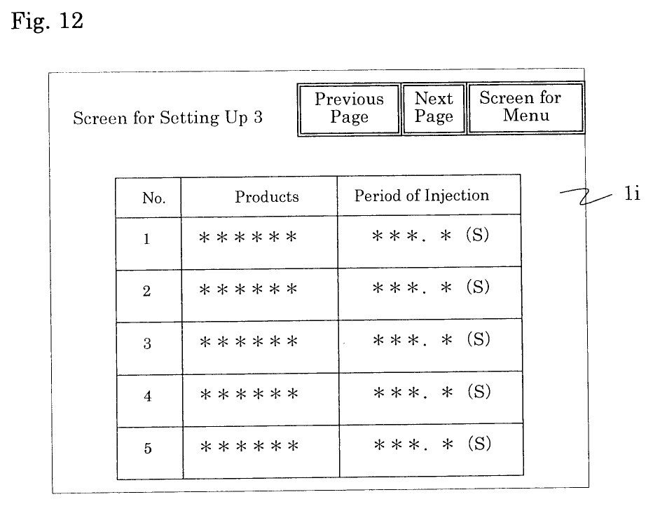

FIG. 13 shows a sample initial screen of a touch panel of an embodiment of these inventions. It is used to confirm the items to be checked to prevent a fire.

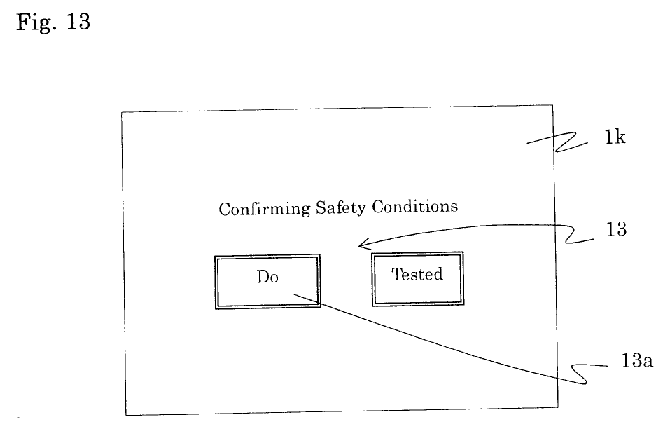

FIG. 14 shows a sample screen of a touch panel of an embodiment of these inventions. It indicates the items to be checked to prevent a fire.

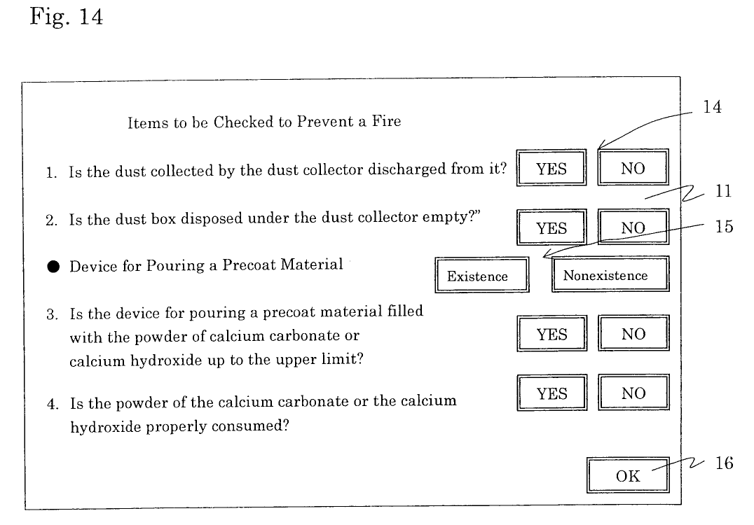

FIG. 15 shows a sample screen of an embodiment of these inventions. It gives instructions to confirm the items to be checked to prevent a fire.

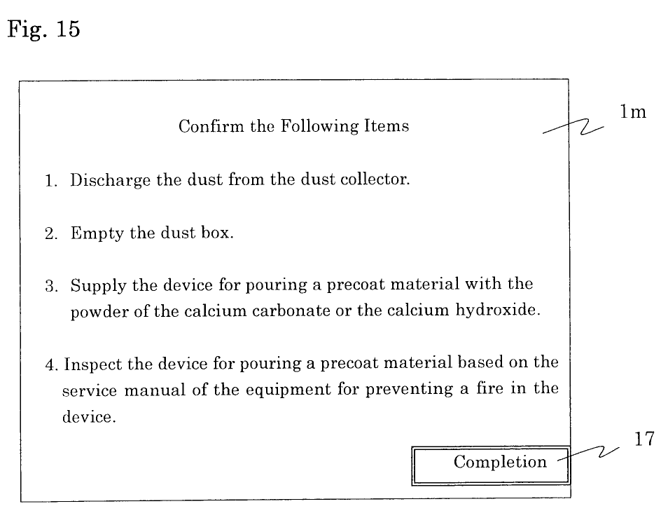

FIG. 16 shows a sample screen of an embodiment of these inventions. It informs the operator that the apparatus is ready to be activated.

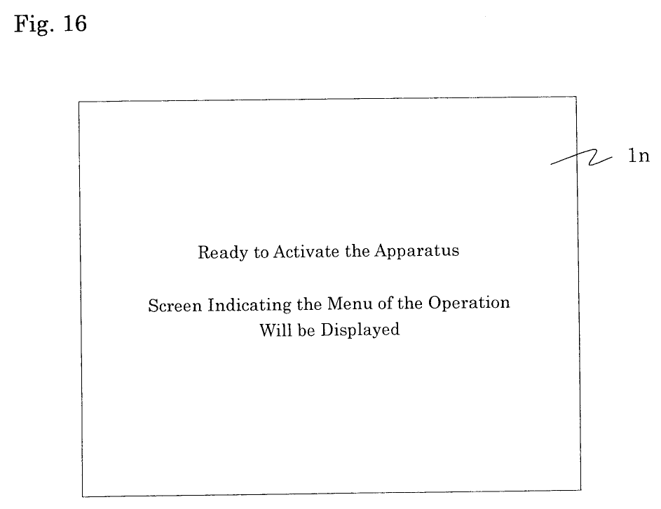

FIG. 17 shows a sample screen of an embodiment of these inventions. It indicates the items to be checked to maintain the apparatus for the shot processing.

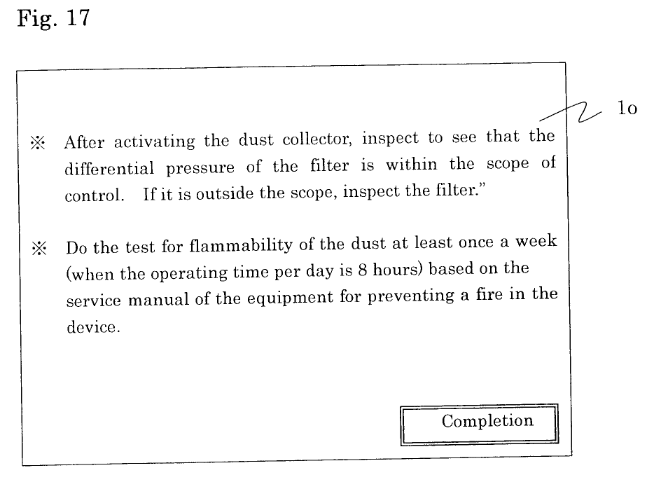

FIG. 18 shows a sample screen indicating items to be checked to confirm the safety of the apparatus when it is activated.

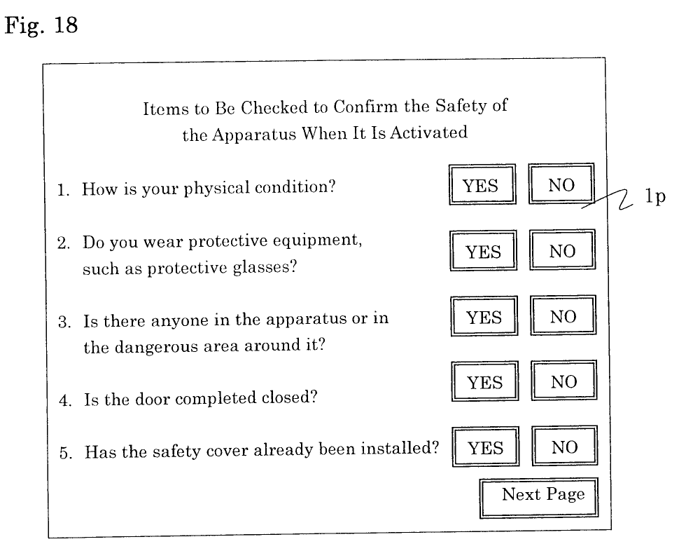

FIG. 19 shows a sample screen giving instructions to confirm that the apparatus for the shot processing can be securely activated.

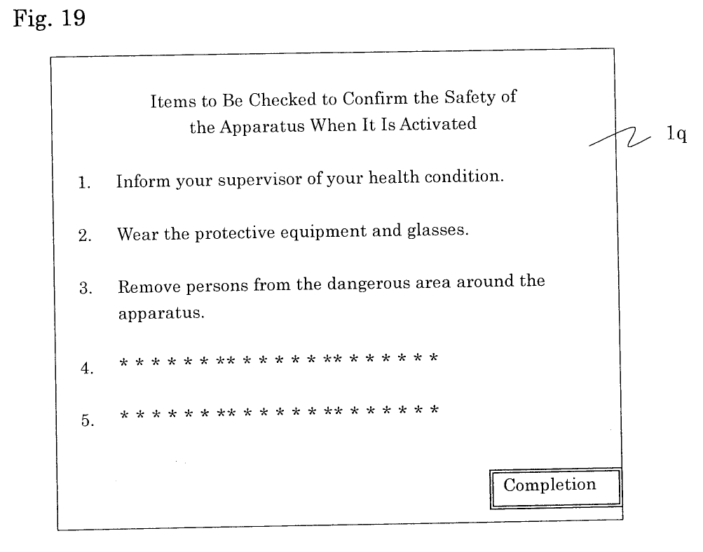

What we claim is:

1. A method for controlling an apparatus for shot processing to securely activate the apparatus, which is provided with a panel for operation, by which the apparatus can be controlled, the method comprising:
a step for displaying a screen indicating predetermined items to be checked to confirm the safety of the apparatus, and displaying key buttons to select answers on the touch panel of the panel for operation when the apparatus is activated,
a step for touching the key buttons to select answers corresponding to the items to be checked,
a step for determining whether it has been confirmed that the apparatus can be securely activated after the step for touching the key buttons, and
a step for switching the screen on the touch panel to a predetermined different screen based on the result of the step for that determination.

2. The method for controlling the apparatus for shot processing according to claim 1, further comprising:
a step for switching the screen of the touch panel to a screen indicating a menu for the operation of the shot processing, if it is judged that the apparatus can be securely activated, and
a step for switching the screen of the touch panel to a screen giving instructions to confirm that the apparatus can be securely activated, if it is judged that the apparatus cannot be securely activated.

3. An apparatus for shot processing, which is provided with a panel for operation to control the apparatus, comprising:
a display means to display a screen indicating predetermined items to be checked to confirm the safety of the apparatus and key buttons to select answers on the touch panel of the panel for operation when the apparatus is activated,
a determining means to determine whether it has been confirmed that the apparatus can be securely activated after touching the key buttons to select answers corresponding to the items to be checked, and
a switching means to switch the screen on the touch panel to a predetermined different screen based on the result of the determining means.

4. An apparatus for shot processing according to claim 3, further comprising:
a switching means to switch the screen of the touch panel to a screen indicating a menu for the operation of the shot processing, if it is judged that the apparatus can be securely activated, and
a switching means to switch the screen of the touch panel to a screen giving instructions to confirm that the apparatus can be securely activated, if it is judged that the apparatus cannot be securely activated.

5. A program for controlling an apparatus for shot processing to securely activate the apparatus, which is provided with a panel for operation and a computer to control the apparatus, the program comprising:
a means for displaying a screen indicating predetermined items to be checked to confirm the safety of the apparatus and key buttons to select answers on the touch panel of the panel for operation when the apparatus is activated,
a means for determining whether it has been confirmed that the apparatus can be securely activated after touching the key buttons to select answers corresponding to the items to be checked, and
a means for switching the screen on the touch panel to a predetermined different screen based on the result of the means for that determination.

6. The program for controlling the apparatus for shot processing according to claim 5, further comprising:
a means for switching the screen of the touch panel to a screen indicating a menu for the operation of the shot processing, if it is judged that the apparatus can be securely activated, and
a means for switching the screen of the touch panel to a screen giving instructions to confirm that the apparatus can be securely activated, if it is judged that the apparatus cannot be securely activated.

7. A method for controlling an apparatus for shot processing to improve the performance of the apparatus, which is provided with a panel for operation to control the apparatus, the method comprising:
a step for inputting names of consumables and periods of consumption of the consumables by means of the touch panel of the panel for operation,
a step for storing the names of the consumables and the periods of the consumption of the consumables, and
a step for displaying a screen giving instructions to exchange the consumables on the touch panel of the panel for operation when a predetermined time has passed.

8. The method for controlling the apparatus for shot processing according to claim 7, further comprising:
a step for determining whether the apparatus has been used for a predetermined period during the operation,
a step for giving instructions to stop the apparatus, if it is judged that the apparatus has not been used for the predetermined period based on the result of the step for that determination.

9. An apparatus for shot processing, which is provided with a panel for operation to control the apparatus, comprising:
an inputting means to input names of consumables and periods of consumption of the consumables by means of the touch panel of the panel for operation,
a storing means to store the names of the consumables and the periods of the consumption of the consumables, and
a display means to display a screen giving instructions to exchange the consumables on the touch panel of the panel for operation when a predetermined time has passed.

10. An apparatus for shot processing according to claim 9, further comprising:
a determining means to determine whether the apparatus has been used for a predetermined period during the operation,
an instructing means to give instructions to stop the apparatus, if it is judged that the apparatus has not been used for the predetermined period based on the result of the determining means.

11. A program for controlling an apparatus for shot processing to improve the performance of the apparatus, which is provided with a panel for operation and a computer to control the apparatus, the program comprising:
a means for inputting names of consumables and periods of consumption of the consumables by means of the touch panel of the panel for operation,
a means for storing the names of the consumables and the periods of the consumption of the consumables, and
a means for displaying a screen giving instructions to exchange the consumables on the touch panel of the panel for operation when a predetermined time has passed.

12. A program for controlling an apparatus for shot processing according to claim 9, further comprising:
a means for determining whether the apparatus has been used for a predetermined period during the operation, and
a means for giving instructions to stop the apparatus, if it is judged that the apparatus has not been used for the predetermined period based on the result of the means for that determination.

13. A method for controlling an apparatus for shot processing to prevent a fire from breaking out in a dust collector, which catches dust generated by the apparatus, and to securely activate the apparatus, which is provided with a panel for operation to control the apparatus, the method comprising:
a step for displaying a screen indicating predetermined items to be checked to prevent a fire from breaking out in the dust collector and key buttons to select answers on the touch panel of the panel for operation when the apparatus is activated,
a step for touching the key buttons to select answers corresponding to the items to be checked,
a step for determining whether it has been confirmed that the apparatus can be securely activated after the step for touching the key buttons, and
a step for switching the screen on the touch panel to a predetermined different screen based on the result of the step for that determination.

14. A method for controlling an apparatus for shot processing according to claim 13, further comprising:
a step for switching the screen of the touch panel to a screen indicating a menu for the operation of the shot processing, if it is judged that the apparatus can be securely activated, and
a step for switching the screen of the touch panel to a screen giving instructions to confirm the state of the apparatus to prevent a fire, if it is judged that the apparatus cannot be securely activated.

15. An apparatus for shot processing having a function that prevents a fire from breaking out in a dust collector, which catches dust generated by the apparatus, and to securely activate the apparatus, which is provided with a panel for operation to control the apparatus, comprising:
a display means to display a screen indicating predetermined items to be checked to prevent a fire from breaking out in the dust collector and key buttons to select answers on a touch panel of the panel for operation when the apparatus is activated,
a determining means to determine whether it has been confirmed that the apparatus can be securely activated after the step for touching the key buttons to select answers corresponding to the items to be checked, and
a switching means to switch the screen on the touch panel to a predetermined different screen based on the result of the determining means.

16. An apparatus for shot processing according to claim 15, further comprising:
a switching means to switch the screen of the touch panel to a screen indicating a menu for the operation of the shot processing, if it is judged that the apparatus can be securely activated, and
a switching means to switch the screen of the touch panel to a screen giving instructions to confirm the state of the apparatus to prevent a fire, if it is judged that the apparatus cannot be securely activated.

17. A program for controlling an apparatus for shot processing to prevent a fire from breaking out in a dust collector, which catches dust generated by the apparatus, which is provided with a panel for operation, by which the apparatus can be controlled, the program comprising:
a means for displaying a screen indicating predetermined items to be checked to prevent a fire from breaking out in the dust collector and key buttons to select answers on the touch panel of the panel for operation when the apparatus is activated,
a means for determining whether it has been confirmed that the apparatus can be securely activated after touching the key buttons to select answers corresponding to the items to be checked, and
a means for switching the screen on the touch panel to a predetermined different screen based on the result of the determining means.

18. A program for controlling an apparatus for shot processing according to claim 17, further comprising:
a means for switching the screen of the touch panel to a screen indicating a menu for the operation of the shot processing, if it is judged that the apparatus can be securely activated, and
a means for switching the screen of the touch panel to a screen giving instructions to confirm the state of the apparatus to prevent a fire, if it is judged that the apparatus cannot be securely activated.
